(19) United States
(12) Patent Application Publication
(10) Pub. No.: US 2022/0383221 A1
(43) Pub. Date: Dec. 1, 2022

(54) BALANCING SAFETY STOCK ATTAINMENT IN A DISTRIBUTION NETWORK BY DELAYING TRANSFER ACTIONS

(71) Applicant: Kinaxis Inc., Ottawa (CA)

(72) Inventors: John HOWAT, Ottawa (CA); Ingrid BONGARTZ, Ottawa (CA); Pascal SCHAEDELI, Ottawa (CA)

(21) Appl. No.: 17/828,561

(22) Filed: May 31, 2022

Related U.S. Application Data
(60) Provisional application No. 63/195,406, filed on Jun. 1, 2021.

(51) Int. Cl. G06Q 10/06; G06Q 10/08

(52) U.S. Cl. CPC G06Q 10/06315; G06Q 10/0875; G06Q 10/06313; G06Q 10/06312

(57) ABSTRACT

Methods and systems that include collection, by a processor, of allotments having an available date before a need date, generation, by the processor, of: one or more supply available events, one or more supply pending events, one or more demand need events, and one or more target change events, processing, by the processor, the one or more supply available events, the one or more supply pending events, the one or more demand need events, and the one or more target change events sequentially until a last event of a day is reached, and processing, by the processor, the last event of the day.

The present application claims the benefit of U.S. Patent Application No. 63/195,406, filed Jun. 1, 2021, and is expressly incorporated by reference in its entirety herein.

### BACKGROUND

In a hub-and-spoke distribution model, both the hub and the spoke may have safety stock levels intended to provide a buffer of supply to meet volatile incoming demands. In situations where supply is available at the hub between when it is desired for safety stock at the hub level and when it is needed to satisfy its driver demand at the spoke, it may be sent out immediately to the spoke, resulting in a “drained hub” scenario (i.e., safety stock attainment that is skewed toward the spokes). It would be more desirable to release such supplies gradually so that attainments are fairer while at the same time not sacrificing demand availability. Fair attainments are desirable because such a situation means that both the hub and spokes are equally capable of satisfying new demands. Furthermore, fair attainments reduce the likelihood of so-called “trans-shipments”, where supply must be sent from a spoke back to a hub, which can result in increased costs.

One approach is to use a workbook to calculate both the target inventory level as well as the current balances (excluding the supplies to be distributed) at the hub and its spokes. These levels are input into an algorithm which calculates a schedule to release the supplies. However, this approach has no ability to influence core planning results. In order to follow the calculated schedule, a subsequent script is executed that firms up supplies at the spokes according to the schedule. This meant that the spokes effectively ask for supply later (according to the schedule), which is equivalent to the hub sending supply later. This needs to be executed level-by-level -that is, an iteration for every hop in the network, since hubs can send to other hubs, and so on, before finally arriving at a terminal node.

There are a number of drawbacks to such an approach: slow computer performance, higher memory usage, and poor user experience.

The computer performance is slow, for a number of reasons. For one, the firming up (of supplies at the spokes according to the schedule) must be done level-by-level, since applying the schedule at one level impacts the availability immediately downstream. After a level is firmed, the core algorithm must be re-executed (to determine the balances described above) before repeating the firming process at the next level. Instead of executing the planning once, the algorithm must be executed for every level of distribution. This represents a significant amount of time and leads to, at minimum, a two-fold slowdown in performance in most cases. This is due to the fact that the plan must be executed at least twice—once to generate the balances and then once to see the results. An additional contribution to slow computer performance is the addition of so many scheduled receipts, which results in slower performance to due version lookup in the database. In some cases, there are over one million such scheduled receipts created. Another reason for slow computer performance is that by adding so many scheduled receipts, there is a slowdown in planning (netting) -due to the way input supplies are handled, versus. calculated supplies. That is, computer performance is slow, even after the act of firming has been executed.

In addition to slow computer performance, memory usage increases due to the large number of scheduled receipts added to the system. Unlike cached results, these cannot be discarded.

The aforementioned drawbacks (slow computer performance, large memory usage) result in poor user experience. Data changes provided by a user (e.g., changing or adding a demand) requires re-running the script and incurring the same technical drawbacks once more. This results in a noticeable (for the user) between the time the user provides the change in data, and the time the user sees the results of those changes.

### BRIEF SUMMARY

Disclosed herein are methods and systems that overcome the technical drawbacks of slow computer performance and high memory usage when balancing safety stock attainment in a distribution network by delaying transfer actions.

Methods and systems disclosed herein, improve computer performance as follows. First, since the core planning process is already accomplished level-by-level, the schedule is modified when supplies are released at the very end. Since the subsequent level has not actually been allocated yet, there's no need to execute the core planning process more than once. Second, since no additional scheduled receipts need to be added, there is no additional cost for the database. The cost refers to memory usage required to store additional scheduled receipts, as well as increased computation time for version resolution. Finally, since no additional scheduled receipts are added, the core planning process runs much more quickly. There is no impact on netting and all of the work can be performed in part of the core planning process that is responsible for determining supply availability and allocating supply to demand. This portion of the core planning process, called “capable to promise” runs faster than netting. This means that the cost of doing the scheduling contributes to the faster part of the process, not the slower part.

Methods and systems disclosed herein reduce the amount of memory usage. While there is a small increase in the amount of temporary calculation memory to perform the calculation in the capable to promise portion, this is more than offset by the reduction of input memory usage for storing a large number of scheduled receipts since temporary memory can be frequently recycled.

Methods and systems disclosed herein enhance user experience, since the scheduling process is transparent to the user. No scripts or other intervention are required other than configuring the capable to promise portion to generate the schedule in the first place.

In one aspect, a computer-implemented method, may comprise: collecting, by a processor, allotments having an available date before a need date; generating, by the processor, one or more supply available events, one or more supply pending events, one or more demand need events, and one or more target change events; processing, by the processor, each of: the one or more supply available events, the one or more supply pending events, the one or more demand need events, and the one or more target change events sequentially until a last event of a day is reached; and processing, by the processor, the last event of the day.

When processing a target change event from the one or more target change events, the computer-implemented method may further comprise: updating, by the processor, a corresponding target.

When processing a supply available event from the one or more supply available events, the computer-implemented method may further comprise: determining, by the processor, an immediacy of the supply available event. If the supply available event is not immediate, the computer-implemented method may further comprise: increasing, by the processor, a balance at a direct destination by a quantity of an allotment. If, on the other hand, the supply available event is immediate, the computer-implemented method may further comprise: setting, by the processor, a pending quantity for a destination to zero; and increasing, by the processor, a balance at the destination by a quantity of an allotment.

When processing a supply pending event from the one or more supply pending events, the computer-implemented method may further comprise: determining, by the processor, an immediacy of the supply pending event. If the supply pending event is immediate, the computer-implemented method may further comprise: determining, by the processor, if the supply pending event is the last event of the day.

If, on the other hand, the supply pending event is not immediate, the computer-implemented method may further comprise: determining, by the processor, if a destination is direct. If the destination is direct, the computer-implemented method may further comprise determining, by the processor, if the supply pending event is the last event of the day. If, on the other hand, the destination is not direct, the computer-implemented method may further comprise: increasing, by the processor, a balance at the destination by a quantity of an allotment.

When processing a demand need event from the one or more demand need events, the computer-implemented method may further comprise: determining, by the processor, an immediacy of an associated supply available event. If the associated supply available event is immediate, the computer-implemented method may further comprise: decreasing, by the processor, a balance pending at a destination by an original quantity of an allotment; and determining, by the processor, if the demand need event is the last event of the day.

On the other hand, if the associated supply available event is not immediate, the computer-implemented method may further comprise: determining, by the processor, if the destination is direct. If the destination is direct, the computer-implemented method may further comprise: decreasing, by the processor, a balance at the destination by a pending quantity on the associated supply available event; and determining, by the processor, if the demand need event is the last event of the day.

If, on the other hand, the destination is not direct, the computer-implemented method may further comprise: transferring, by the processor, any remaining pending quantity on an allotment on a current date; reducing, by the processor, a balance at the destination by a quantity transferred in the demand need event; reducing, by the processor, the balance at the destination by an amount previously transferred from the allotment prior to the demand need event; reducing, by the processor, an amount of transfer pending for the destination by the quantity transferred in the demand need event; and determining, by the processor, if the demand need event is the last event of the day.

When processing the last event of the day, the computer-implemented method may further comprise: determining, by the processor, one or more ideal transfer quantities for each active destination; rounding, by the processor, a total transfer quantity based on a lot size policy; transferring, by the processor, pending supplies up to the rounded total transfer quantity; updating, by the processor, balances and/or pending quantities; and tracking, by the processor, an accumulated rounding error at each destination. Other technical features may be readily apparent to one skilled in the art from the following figures, descriptions, and claims.

In one aspect, a system can include a processor. The system may also include a memory storing instructions that, when executed by the processor, configure the system to: collect, by the processor, allotments having an available date before a need date; generate, by the processor, one or more supply available events, one or more supply pending events, one or more demand need events, and one or more target change events; process, by the processor, each of: the one or more supply available events, the one or more supply pending events, the one or more demand need events, and the one or more target change events sequentially until a last event of a day is reached; and process, by the processor, the last event of the day.

When processing a target change event from the one or more target change events, the system can be further configured to: update, by the processor, a corresponding target.

When processing a supply available event from the one or more supply available events, the system can be further configured to: determine, by the processor, an immediacy of the supply available event. If the supply available event is not immediate, the system can be further configured to: increase, by the processor, a balance at a direct destination by a quantity of an allotment. If, on the other hand, the supply available event is immediate, the system can be further configured to: set, by the processor, a pending quantity for a destination to zero; and increase, by the processor, a balance at the destination by a quantity of an allotment.

When processing a supply pending event from the one or more supply pending events, the system can be further configured to: determine, by the processor, an immediacy of the supply pending event. If the supply pending event is immediate, the system can be further configured to: determine, by the processor, if the supply pending event is the last event of the day.

If, on the other hand, the supply pending event is not immediate, the system may be further configured to: determine, by the processor, if a destination is direct. If the destination is direct, the system can be further configured to: determine, by the processor, if the supply pending event is the last event of the day. If, on the other hand, the destination is not direct, the system can be further configured to: increase, by the processor, a balance at the destination by a quantity of an allotment.

When processing a demand need event from the one or more demand need events, the system can be further configured to: determine, by the processor, an immediacy of an associated supply event. If the associated supply available event is immediate, the system can be further configured to: decrease, by the processor, a balance pending at a destination by an original quantity of an allotment; and determine, by the processor, if the demand need event is the last event of the day.

On the other hand, if the associated supply available event is not immediate, the system can be further configured to: determine, by the processor, if the destination is direct. If the destination is direct, the system can be further configured to: decrease, by the processor, a balance at the destination by a pending quantity on the associated supply event; and determine, by the processor, if the demand need event is the last event of the day.

On the other hand, if the destination is not direct, the system can be further configured to: transfer, by the processor, any remaining pending quantity on an allotment on a current date; reduce, by the processor, a balance at the destination by a quantity transferred in the demand need event; reduce, by the processor, the balance at the destination by an amount previously transferred from the allotment prior to the demand need; reduce, by the processor, an amount of transfer pending for the destination by the quantity transferred in the demand need event; and determine, by the processor, if the demand need event is the last event of the day.

When processing the last event of the day, the system can be further configured to: determine, by the processor, one or more ideal transfer quantities for each active destination; round, by the processor, a total transfer quantity based on a lot size policy; transfer, by the processor, pending supplies up to the rounded total transfer quantity; update, by the processor, balances and/or pending quantities; and track, by the processor, an accumulated rounding error at each destination. Other technical features may be readily apparent to one skilled in the art from the following figures, descriptions, and claims.

In one aspect, a non-transitory computer-readable storage medium, the computer-readable storage medium can include instructions that when executed by a computer, cause the computer to: collect allotments having an available date before a need date; generate one or more supply available events, one or more supply pending events, one or more demand need events, and one or more target change events; process each of: the one or more supply available events, the one or more supply pending events, the one or more demand need events, and the one or more target change events sequentially until a last event of a day is reached; and process the last event of the day.

When processing a target change event from the one or more target change events, the computer can be further configured to update a corresponding target.

When processing a supply available event from the one or more supply available events, the computer can be further configured to: determine an immediacy of the supply available event. If the supply available event is not immediate, the computer can be further configured to: increase a balance at a direct destination by a quantity of an allotment. On the other hand, if the supply available event is immediate, the computer can be further configured to: set a pending quantity for a destination to zero; and increase a balance at the destination by a quantity of an allotment.

When processing a supply pending event from the one or more supply pending events, the computer can be further configured to: determine an immediacy of the supply pending event. If the supply pending event is immediate, the computer can be further configured to: determine if the supply pending event is the last event of the day.

If, on the other hand, the supply pending event is not immediate, the computer can be further configured to: determine if a destination is direct. If the destination is direct, the computer can be further configured to: determine if the supply pending event is the last event of the day. On the other hand, if the destination is not direct, the computer can be further configured to: increase a balance at the destination by a quantity of an allotment.

When processing a demand need event from the one or more demand need events, the computer can be further configured to: determine an immediacy of an associated supply event. If the associated supply available event is immediate, the computer can be further configured to: decrease a balance pending at a destination by an original quantity of an allotment; and determine if the demand need event is the last event of the day.

On the other hand, if the supply available event is not immediate, the computer can be further configured to: determine if the destination is direct. If the destination is direct, the computer can be further configured to: decrease a balance at the destination by a pending quantity on the associated supply event; and determine if the demand need event is the last event of the day.

On the other hand, if the destination is not direct, the computer can be further configured to: transfer any remaining pending quantity on an allotment on a current date; reduce a balance at the destination by a quantity transferred in the demand need event; reduce the balance at the destination by an amount previously transferred from the allotment prior to the demand need event; reduce an amount of transfer pending for the destination by the quantity transferred in the demand need event; and determine if the demand need event is the last event of the day.

When processing the last event of the day, the computer can be further configured to: determine one or more ideal transfer quantities for each active destination; round a total transfer quantity based on a lot size policy; transfer pending supplies up to the rounded total transfer quantity; update balances and/or pending quantities; and track an accumulated rounding error at each destination. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter will become apparent from the description, the drawings, and the claims.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for sub-day planning in accordance with one embodiment.

FIG. 2 illustrates a technical approach in accordance with one embodiment.

FIG. 3 illustrates an example in accordance with one embodiment.

FIG. 4 illustrates an overall flowchart in accordance with one embodiment.

FIG. 5 illustrates a flowchart for a target change event subroutine in accordance with one embodiment.

FIG. 6 illustrates a flowchart for a supply available event subroutine in accordance with one embodiment.

FIG. 7 illustrates a flowchart for a supply pending event subroutine in accordance with one embodiment.

FIG. 8 illustrates a flowchart for a demand need event subroutine in accordance with one embodiment.

FIG. 9 illustrates a flowchart for a last day of event subroutine in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

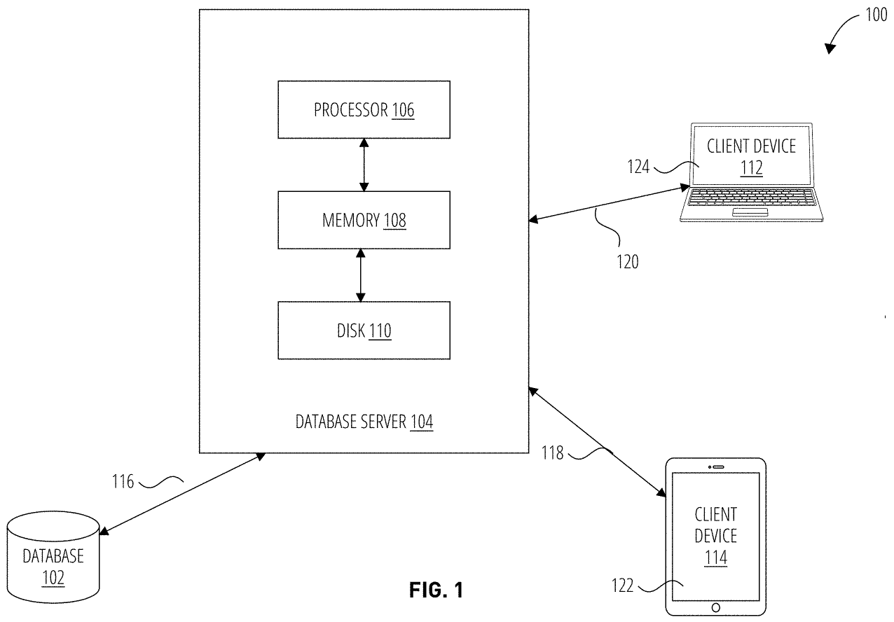

FIG. 1 illustrates an example of a system for sub-day planning in accordance with one embodiment.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

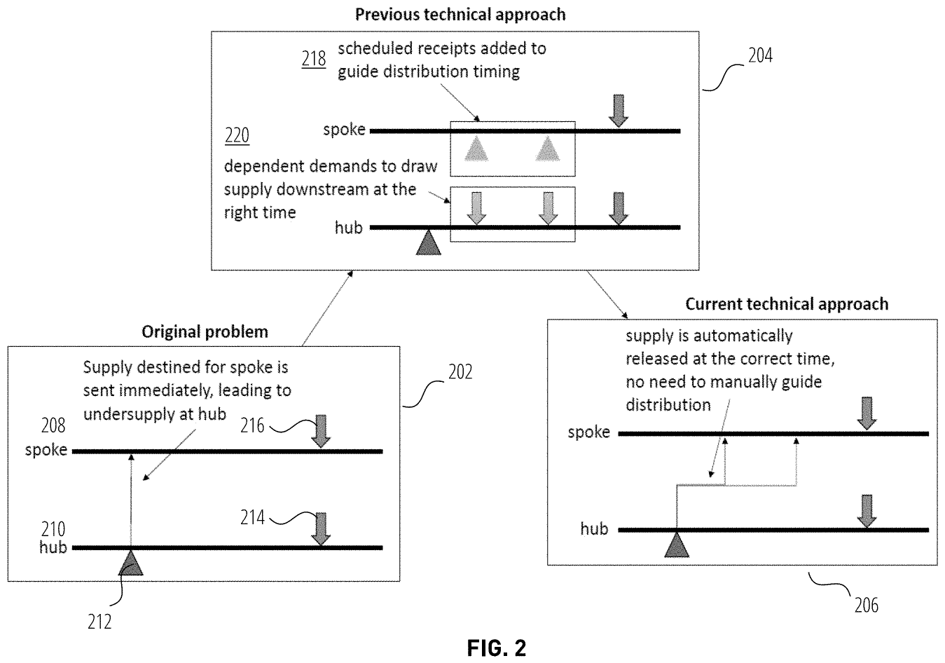

FIG. 2 illustrates a technical approach 206 in accordance with one embodiment.

In FIG. 2, the original problem 202 refers to supply 212 destined for spoke 208 (from hub 210). that is sent immediately, leading to undersupply at hub 210. The actual driving demands at each level are indicated by 214 and 216.

A previous technical approach 204 to solving original problem 202 includes adding scheduled receipts 218 to guide distribution timing. The scheduled receipts 218 generate dependent demands 220 which draw supply downstream at the right time.

There are a number of drawbacks to such an approach: slow computer performance, higher memory usage, and poor user experience.

The computer performance is slow, for a number of reasons. For one, the firming up (of supplies at the spokes according to the schedule) must be done level-by-level, since applying the schedule at one level impacts the availability immediately downstream. After a level is firmed, the core algorithm must be re-executed (to determine the balances described above) before repeating the firming process at the next level. Instead of executing the planning once, the algorithm must be executed for every level of distribution. This represents a significant amount of time and leads to, at minimum, a two-fold slowdown in performance in most cases. This is due to the fact that the plan must be executed at least twice—once to generate the balances and then once to see the results. An additional contribution to slow computer performance is the addition of so many scheduled receipts, which results in slower performance to due version lookup in the database. In some cases, there are over one million such scheduled receipts created. Another reason for slow computer performance is that by adding so many scheduled receipts, there is a slowdown in planning (netting) -due to the way input supplies are handled, versus. calculated supplies. That is, computer performance is slow, even after the act of firming has been executed.

In addition to slow computer performance, memory usage increases due to the large number of scheduled receipts added to the system. Unlike cached results, these cannot be discarded.

The aforementioned drawbacks (slow computer performance, large memory usage) result in poor user experience. Data changes provided by a user (e.g., changing or adding a demand) requires re-running the script and incurring the same technical drawbacks once more. This results in a noticeable (for the user) between the time the user provides the change in data, and the time the user sees the results of those changes.

A current technical approach 206 illustrates how the supply is automatically released at the correct time, and that there is no need to manually guide distribution.

Technical approach 206 overcomes the technical drawbacks of slow computer performance and high memory usage when balancing safety stock attainment in a distribution network by delaying transfer actions.

Technical approach 206 improves computer performance as follows. First, since the core planning process is already accomplished level-by-level, the schedule is modified when supplies are released at the very end. Since the subsequent level has not actually been allocated yet, there's no need to execute the core planning process more than once. Second, since no additional scheduled receipts need to be added, there is no additional cost for the database. The cost refers to memory usage required to store additional scheduled receipts, as well as increased computation time for version resolution. Finally, since no additional scheduled receipts are added, the core planning process runs much more quickly. There is no impact on netting and all of the work can be performed in part of the core planning process that is responsible for determining supply availability and allocating supply to demand. This portion of the core planning process, called “capable to promise” runs faster than netting. This means that the cost of doing the scheduling contributes to the faster part of the process, not the slower part.

Methods and systems disclosed herein reduce the amount of memory usage. While there is a small increase in the amount of temporary calculation memory to perform the calculation in the capable to promise portion, this is more than offset by the reduction of input memory usage for storing a large number of scheduled receipts since temporary memory can be frequently recycled.

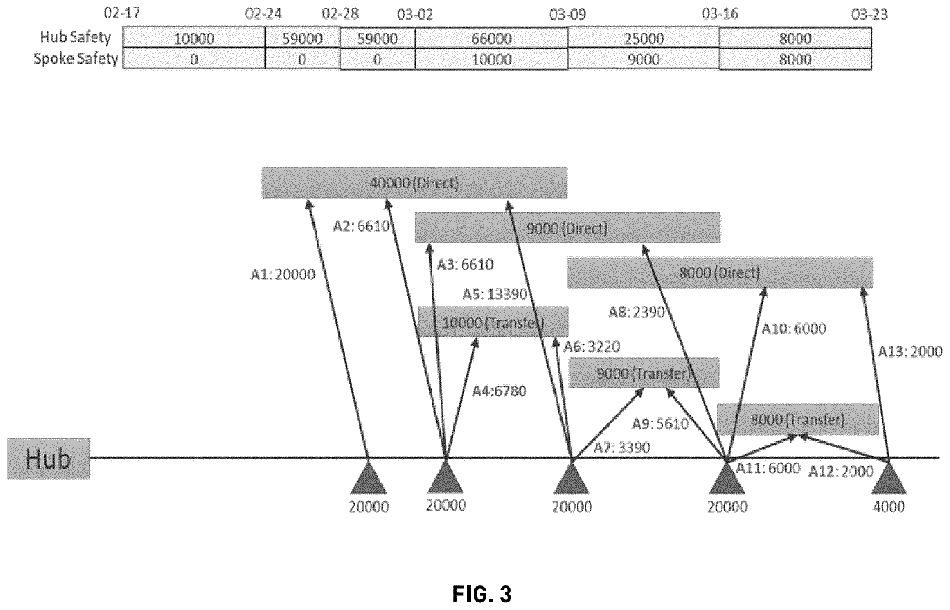

FIG. 3 illustrates an example in accordance with one embodiment.

The input to the problem is a set of allotments (allocations) at a hub to both direct demands (i.e., demands at the hub) as well as demands originating from spokes.

These allotments can originate from the output of an algorithm, or from another source of allotments. However, the quality of the solution depends on the quality of the initial set of allotments.

Both the hub and the spokes are each assumed to maintain a safety stock. Safety stock levels (or “targets”) are typically a function of demand quantity (in a “days of coverage” setup), but can be manually specified instead.

Supply originally reserved for safety stock can eventually be used to satisfy demands. Therefore, one can think of a demand that consumes supply previously in safety stock as being offset to the date that the safety stock level increased. This date is referred to as the demand's due date, while the date that the supply is actually needed to satisfy the demand is the demand's need date.

In this disclosure, the intention is for supplies that are allocated at the hub to dependent demands from a spoke, will spend time covering safety stock at both the hub and the spoke.

However, the act of allocating supply to a spoke demand can be interpreted as an indication that it should be transferred immediately to the spoke. This results in a “drained hub” scenario, where safety stock attainment is skewed toward the spokes.

It is more desirable to release the supplies gradually so that attainments are fairer (i.e., the ratio of actual safety stock to target safety stock is as equal as possible for the hub and spokes). Such fairness is desirable because it means that the hub and spokes are both equally capable of satisfying new demands. Additionally, such fairness reduces the likelihood of so called “trans-shipments”, where supply must be sent from a spoke back to a hub, often at a higher cost.

In one aspect, there is provided a system to determine the schedule that supply should be released from hub to spoke to balance safety stock attainment as much as possible. Allocation decisions are not changed: the total amount of each supply allocated to each demand is the same; it is rather the timing of these allocations that differ. Allocations may be split into several pieces, as a result. Allocations are never delayed beyond the demand's need date, since doing so would negatively impact the satisfaction of real demands. Therefore, the crux of the problem is to determine the quantity of each allocation that is released between the supply's available date and the demand's need date.

A consequence of this is that non-early allocations (those for which the supply available date is on or after the demand need date) are not considered. Only allocations to spokes are eligible to be delayed, since allocations to demands directly at the hub only cover safety stock at the hub.

Some allocations will be referred to as immediate transfers. Such allocations are also not eligible to be delayed. These include: any dependent demands that are not transfers (for example, due to a bill of material relationship); and any dependent demand that originates from a spoke that does not maintain safety stock. The schedule over which to release supply should respect transportation lot sizing policies.

The method and system each maintain several primary sets of values, such as (but not limited to):

1) a current balance at each destination, including the hub itself (the “direct” destination).

2) a current target safety stock level at each destination, including the hub itself. Targets are offset by lead time as appropriate so that they reflect what the safety stock level would be at the receiving destination for supply allocated on the current date. There are two possible alternative definitions of “target safety stock level”: the safety stock required at the destination itself; or the cumulative safety stock, offset by lead time at each level, for the destination and all of its downstream destinations.

3) The amount of transfer pending at the hub for each destination. This is the quantity at the hub destined for each spoke that has not actually been transferred yet. The above assumes that the destinations that receive from the hub “pull” their supply from the hub and should not generally be above 100% attainment (to within a lot size, ignoring any input supplies already there). Therefore, supply is not considered pending until the due date of the demand to which it is allocated. However, such supply still increases the balance at the hub. An alternative implementation is to allow the pending supply to be considered as soon as it is available, although doing so would require the destination site to be able to recognize supply at that date. This essentially amounts to a “push” configuration.

4) The accumulated “rounding error” at each destination other than the direct destination. This quantity will be used to ensure that when applying rounding due to lot sizing policies, there is no undue bias toward the same destination consistently.

The system and method are each event-based and consider different types of events, such as: supply available events; supply pending events; demand need events; and target change events, each of which is further described below. Each event has associated with it a date and a destination, as well as some event-specific auxiliary data.

### Supply Available Events

One such event per allotment that is available strictly before its demand's need date. The date of the event is the date the supply is available. The destination of the event is the destination from which the allocated demand originates. The event may be considered immediate if either of the following holds:

the supply satisfies a demand that is neither a direct demand at the hub nor a transfer to a receiving site (e.g., an allocation in a bill of material relationship); or

the supply satisfies a demand from a destination without safety stock (i.e., no positive target anywhere in the horizon).

The event (or, equivalently, the allotment) tracks the original quantity of the allotment as well as how much has been transferred (initially zero). An alternative implementation would track the latter on the Supply Pending Event, described next.

### Supply Pending Events

One such event per allotment that is available strictly before its demand's need date. The date of the event is the later of the date the supply is available and the date the allocated demand is due. The destination of the event is the destination from which the allocated demand originates. This type of event can be omitted in a configuration where the hub is permitted to push to the spokes. In this case, all activities described for a Supply Pending Event will take place as part of processing the associated Supply Available Event (i.e., the Supply Available Event associated with the same allotment).

### Demand Need Events

One such event per allotment that is available strictly before its demand's need date. The date of the event is the date the allocated demand is needed. The destination of the event is the destination from which the allocated demand originates. The event maintains a link to the associated Supply Available Event. The event (or, equivalently, the allotment) tracks the original quantity of the allotment.

### Target Change Event

One such event per change in safety stock target (applying either definition of “target safety stock level”) given above at any receiving site or the hub itself. The date of the event is the date of the change of level, offset by lead time as appropriate to be normalized to a date at the hub. The destination of the event is the destination whose target safety stock level changed. The event also tracks the quantity of the new level (or, equivalently, the difference between the new level and the previous).

The system and method each proceed by generating all of the events described above by iterating over the set of allotments and the set of destinations. Events are sorted for processing in the following way:

By date (non-decreasing);

By event type (for events on the same date):
1. Target Change Events; then
2. Supply Available Events; then
3. Supply Pending Events; then
4. Demand Need Events

By the order the events were created (non-decreasing).

The system and method each then process the events in sequence while maintaining the sets of values described above.

For a Target Change Event: change the current target safety stock level at the given destination to the given value.

For a Supply Available Event:

If the event is immediate, then the pending quantity tracked by the event is set to zero and the balance at the destination is increased by the quantity of the allotment.

Otherwise, if the event is not immediate, then the balance at the direct destination is increased by the quantity of the allotment.

For a Supply Pending Event:

If the corresponding supply available event is immediate or if the destination of the event is the direct destination, then no action is performed.

Otherwise, the amount of transfer pending is increased by the quantity of the allotment.

For a Demand Need Event:

If the associated Supply Available Event is immediate, then the balance at the destination is decreased by the original quantity of the allotment.

Otherwise, if the destination is the direct destination, then the balance at the direct destination is decreased by pending amount on the associated Supply Available Event.

Otherwise, if neither of the previous conditions are true, then:
1. Transfer any remaining pending quantity on this allotment on the current date.
2. Reduce the balance at the direct destination by the amount that was transferred in the previous step.
3. Reduce the balance at the destination by the amount that was already transferred there prior to this event. (Equivalently, increase it by the quantity transferred in Step 1 minus the original quantity of the allotment.)
4. Reduce the amount of transfer pending by the quantity transferred in Step 1.

After the last event on a given date is processed, the following actions are performed:

Determine the ideal transfer quantities for each destination:

Determine the set of active destinations. This is the set of destinations that have positive transfer pending quantity, positive target. In a pull configuration, the balance should also be strictly less than the target.

Calculate the ideal transfer quantities.

Denote the direct destination by D₀, and the set of active destinations by D₁, . . . ,Dₙ.

Denote the target at D₀ by T₀, and the targets at by D₁, . . . ,Dₙ, by T₁, . . . ,Tₙ, respectively.

If T₀ =0, the ideal quantity for each destination is simply the pending quantity for that destination, and so the algorithm can resume at the conversion to actual quantities below.

Denote the balance at D₀ by B₀, and the targets at D₁ , . . . ,Dₙ , by B₁, . . . ,Bₙ, respectively.

Denote the transfer pending quantity at D₁, . . . ,Dₙ by P₁, . . . ,Pₙ, respectively.

The goal is to determine the ideal quantities x₁, . . . ,xₙ to send to D₁, . . . ,Dₙ, respectively, ignoring lot sizing policies for now.

After the transfers are performed, the balance at the receiving sites will increase by the quantity sent to each, while the direct destination's balance will decrease by the total quantity transferred. In particular:

The attainment at Dᵢ>0 will become (Bᵢ+xᵢ)/Tᵢ.

The attainment at L will become:

$$( {B}_{0} - {\sum }_{i = 1}^{n} {x}_{i} ) / {T}_{0} .$$

Therefore, ideal transfer quantities can be obtained by solving the following system of equations:

$$( {B}_{1} + {x}_{1} ) / {T}_{1} = … = ( {B}_{n} + {x}_{n} ) / {T}_{n} = ( {B}_{0} - {\sum }_{i = 1}^{n} {x}_{i} ) / {T}_{0} .$$

The solution can be determined using any of a variety of known techniques (for example, Gaussian elimination with back substitution).

However, not all solutions are admissible because of the additional constraint that 0≤xᵢ≤Pᵢ for all 1≤i≤n

Therefore, solve the system iteratively. At the end of each solve, determine if any destination Dᵢ has an inadmissible solution xᵢ such that either xᵢ<0, or xᵢ >Pᵢ . If so, find a destination Dₘ in maximal violation over all destinations with inadmissible solutions, where the size of a violation for destination Dᵢ is considered to be:

xᵢ−Pᵢ, if xᵢ>Pᵢ; and

|xᵢ|if xᵢ≤0.

Repair the solution in the following way:

If xₘ >Pₘ, fix xₘ=Pₘ;

If Xₘ <0, fix xₘ=0.

Perform another iteration, replacing all occurrences of xₘ with the fixed value assigned to it.

When this process ends, 0≤xᵢ≤Pᵢ, for all 0≤i≤n, as desired. Observe that any iteration is either the last iteration or fixes at least one variable and so the process will eventually stop.

Now that the ideal transfer quantities have been calculated, they can be converted to actual quantities. The key distinction is that the actual quantities must consider rounding due to lot sizing policies.

The transportation lot size L is assumed to be consistent between destination sites. If this is not the case L=1. In a “pull” configuration, the hub should absorb most of the impact due to rounding:

The total ideal quantity to be transferred is:

$$x = {\sum }_{i = 1}^{n} {x}_{i} .$$

If x is not a multiple of L, round down to the previous multiple, say x′<Otherwise, set

An alternative implementation would be rounding up to the next multiple or rounding to the nearest multiple of L. This would be more suitable in a “push” configuration, but could be implemented in a “pull” configuration, albeit with possibly reduced solution quality.

Another alternative implementation would be to round up, or down, depending on the quantity of the resulting attainment at Do. If rounding x up to the next multiple of L, say x+would result in Dₒ −x⁺≥Tₒ, then it is safe to set x′ to the smallest multiple of L that is larger than x, since the attainment at the hub will not be adversely impacted by rounding up (i.e., it will still be at full attainment). Otherwise, x′ is set to the greatest multiple of L that is smaller than x.

The total transfer quantity x′ has now been determined, and so the individual transfer quantities can be determined next.

The next element from the set of active destinations (described above) is removed from the set, where “next” is defined as the destination with:

minimum accumulated rounding error; then

maximum ideal transfer quantity, as calculated previously; then

the lexicographically smallest destination part name and part site. Alternative implementations could consider any total ordering of the destination sites for this final tie-breaker.

Suppose the next destination to process is Dᵢ. If xᵢ<L, transfer L to Dᵢ on the current date, unless L >Pᵢ, in which case transfer nothing. Otherwise, round xᵢ to the previous multiple of L, say x′ᵢ, and transfer min (x′ᵢ, Pᵢ) to Dᵢ on the current date.

In either case, reduce both Xᵢ and x′ᵢ by the quantity actually transferred.

The actual supplies transferred are the earliest pending supplies for that destination (i.e., the earliest allotment or set of allotments whose Supply Pending Event has occurred but whose Demand Need Event has not yet occurred and has positive pending quantity).

An allotment may need to be split into two allotments during this process as needed if only part of an allotment should be transferred on a given date. In this case, the supply and demand would remain the same, but the transfer dates could differ.

If any of the following are true, remove Dᵢ from the set of active destinations:

The quantity transferred in the previous step was zero;

Pᵢ<0;

xᵢ≤0.

Repeat the above steps until the set of active destinations is empty or x′ᵢ≤0.

Once all transfers are complete for this date, adjust the accumulated rounding error at Dᵢ by subtracting xᵢ. This means that destinations that have residual ideal transfer quantity that was not actually transferred will have smaller rounding error and be considered first on subsequent dates. An alternative implementation would be to increase the value here and sort in non-increasing sequence when determining the next destination in the set of active destinations.

### Example

Consider the following setup at a hub that serves a single spoke.

The table at the top in FIG. 3 represents the safety stock levels at the hub (top row) and the spoke (bottom row).

The rectangles represent the intervals between demand due dates (left side) and need dates (right side). The quantities inside the rectangles represent the demand quantity and they are also labeled as either being direct (demands at the hub) or transfer (originating from the spoke).

The triangles represent supply availability at the hub.

The arrows represent allocation of supply to demand, with the quantity of the allotment indicated by the number next to the arrow. They are labelled A1 . . . A13.

The system and method each do not consider how this initial set of allotments is created and applies to any set of input allotments. However, it is desirable for the set of allotments to be as fair as possible (satisfying real demands first and then filling up safety stock, fair-sharing as needed).

The example here is based on the output of an algorithm disclosed in U.S. Ser. No. 17/105,585 (filed Nov. 26, 2020), incorporated herein by reference.

For simplicity, there is zero lead time and the only restriction on the transportation lot size is that it must a whole number.

Note that there are no events processed for allotments A5, A6, A8, A9, Al2, and A13 because these allotments are for supply that is available on their associated demand's need date.

According to the Table in FIG. 3:

On 02-17: Target Change Event for hub to 10000. No transfers take place because there is no pending supply.

On 02-24: Target Change Event for hub to 59000. No transfers take place because there is no pending supply.

On 02-28: Supply Available Event for A1: increase hub balance to 20000. Supply Pending Event for A1: no action (direct demand). No transfers take place because there is no pending supply.

On 03-02: Target Change Event for hub to 66000 and spoke to 10000. Supply Available Event for A2, A3, and A4: increase hub balance to 20,000+6,610+6,610+6,780 =40,000. Supply Pending Event for A2 and A3: no action (direct demand). Supply Pending Event for A4: increase pending supply for spoke to 6780. Since there is pending supply, determine the amount to transfer:
Current balance is 0 at spoke, 40000 at hub.
Current target is 10000 at spoke, 66000 at hub.
Pending supply for spoke is 6780.
If x is the amount to transfer, solve x/10000=(40000−x)/66000 , which has solution x≈5263. Observe that x is admissible because 0≤x≤6780.
Therefore, transfer 5263 of A4 on 03-02:
   Increase spoke balance to 5263.
   Reduce hub balance to 40000−5263=1517,
   Decrease pending supply for spoke to 6780−5263=1517,
Observe that hub attainment is 34737 /66000≈53% and spoke attainment is 5263 /10000≈53%

On 03-09:
Target Change Event for hub to 25000 and spoke to 9000.
Supply Available Event for A5, A6, and A7: increase hub balance to 34737+3390 =38127.
Supply Pending Event for A6 and A7: increase pending supply for spoke to 1517+3220+3390=8127.
Demand Need Event for A1, A2, and A5: decrease hub balance to 54737 −20000−6610−13390=14737.
Demand Need Event for A4 and A6:
   A4 has 1517/6780 that is not transferred, so transfer it on 03-09.
      Decrease hub balance to 14737−1517=13220.
      Decrease spoke balance to 5603−(6780−1517)=0
      Decrease supply pending for spoke to 8127−1517=6780.
   A6 has 3220/3220 that is not transferred, so transfer it on 03-09.
      Decrease hub balance to 13220−3220=10000.
      Decrease spoke balance to 0−(3220−3220)0.
      Decrease supply pending for spoke to 6780−3220=3390.
Since there is pending supply, determine the amount to transfer:
   Current balance is 0 at spoke, 10000 at hub.
   Current target is 9000 at spoke, 25000 at hub.
   Pending supply for spoke is 3390.
   If x is the amount to transfer, solve x/9000=(10000−x)/25000, which has solution x≈2647.
   Observe that is admissible because 0≤x≤3390.
   Therefore, transfer 2647 of A7 on 03-09:
      Increase spoke balance to 2647.
      Reduce hub balance to 10000 −2647=7353.
      Decrease pending supply for spoke to 3390−2647=743.
   Observe that hub attainment is 7353 /25000 ≈29% and spoke attainment is 2647/9000≈29%.

On 03-16:
Target Change Event for hub to 8000 and spoke to 8000.
Supply Available Event for A8, A9, A10, and A11: increase hub balance to 7353+2390+5610+6000+6000=27353.
Supply Pending Event for A8 and A10: no action (direct demand).
Supply Pending Event for A9 and A11: increase pending supply for spoke to 743+5610+6000=12353.
Demand Need Event for A3 and A8: decrease hub balance to 27353−6610−2390=18353.
Demand Need Event for A7 and A9
   A7 has 743/3390 untransferred, so transfer it on 03-16.
      Decrease hub balance to 18353−743=17610.
      Decrease spoke balance to 2467−(3390−743)=0.
      Decrease supply pending for spoke to 12353−743=11610.
   A9 has 5610/5610 untransferred, so transfer it on 03-16.
      Decrease hub balance to 17610−5610=12000.
      Decrease spoke balance to 0−(5610−5610)=0.
      Decrease supply pending for spoke to 11610−5610=6000.
Since there is pending supply, determine the amount to transfer:
   Current balance is 0 at spoke, 12000 at hub.
   Current target is 8000 at spoke, 8000 at hub.
   Pending supply for spoke is 6000.
   If is the amount to transfer, solve x/8000=(12000−x)/8000, which has solution X=6000.
   Observe that is admissible because 0≤x≤6000.
   Therefore, transfer 6000 of A11 on 03-16:
      Increase spoke balance to 6000.
      Reduce hub balance to 12000−6000=6000.
      Decrease pending supply for spoke to 6000−6000=0.
   Observe that hub attainment is 6000/8000=75% and spoke attainment is 6000/8000 =75%.

On 03-23:
Target Change Event for hub to 0 and spoke to 0.
Supply Available Event for A12 and A13: increase hub balance to 6000+2000+2000=10000.
Supply Pending Event for A13: no action (direct demand).
Supply Pending Event for A12: increase pending supply for spoke to 2000.
Demand Need Event for A10 and A13: decrease hub balance to 10000−2000−2000=6000.
Demand Need Event for A11 and A12
   A11 has 0/6000 untransferred, so there is nothing new to transfer.
      Decrease hub balance to 2000−0=2000.
      Decrease spoke balance to 6000−6000=0.
      Decrease supply pending to spoke to 2000−0=2000.
   A12 has 2000/2000 untransferred, so transfer 2000 on 03-23.
      Decrease hub balance to 2000−0=2000.
      Decrease spoke balance to 0 (2000−2000)=0.
      Decrease supply pending to spoke to 2000 −0=2000.
No additional transfers take place because there is no pending supply.

To summarize, the key output is the following schedule of transfers:
A4: transfer 5263 on 03-02 and the remaining 1517 on 03-09.
A6: transfer entire 3220 on 03-09.
A7: transfer 2647 on 03-09 and the remaining 743 on 03-16.
A9: transfer entire 5610 on 03-16.
A11: transfer entire 6000 on 03-16.
Al2: transfer entire 2000 on 03-23.

Observe that the attainments on 03-02, 03-09, and 03-16 are equal, as desired.

The process starts at 402; at 404 allotments with AvailableDate strictly before NeedDate are collected. From this step, there are generated four steps: block 408 (generation of Supply Available Events); block 416 (generation of Supply Pending Events); block 422 (generation of Demand Need Events) and block 426 (generation of Target Change Events). Each of the generated events is processed sequentially at decision block 418. Once all of the generated events are process, the process ends at 406.

Each of the generated events is processed by its respective subroutine: Target Change Events (block 426) are processed by a Target Change Event Subroutine (block 410); Supply Available Events (block 408) are processed by a Supply Available Event Subroutine (block 420); Supply Pending Events (block 416) are processed by a Supply Pending Event Subroutine (block 424); and Demand Need Events (block 422) are processed by a Demand Need Event Subroutine (block 428).

After concluding each of the subroutines, the process proceeds to decision block 412 to determine the next step, depending on whether the processed event is the last event of the day or not. If not, then the process reverts to decision block 418, If it is the last event of the day, then the process proceeds to a Last Event of Day Subroutine (block 414), before proceeding to decision block 418.

Each of the subroutines Target Change Event Subroutine (block 410), Supply Available Event Subroutine (block 420), Supply Pending Event Subroutine (block 424), Demand Need Event Subroutine (block 428), and Last Event of Day Subroutine (block 414), is described below.

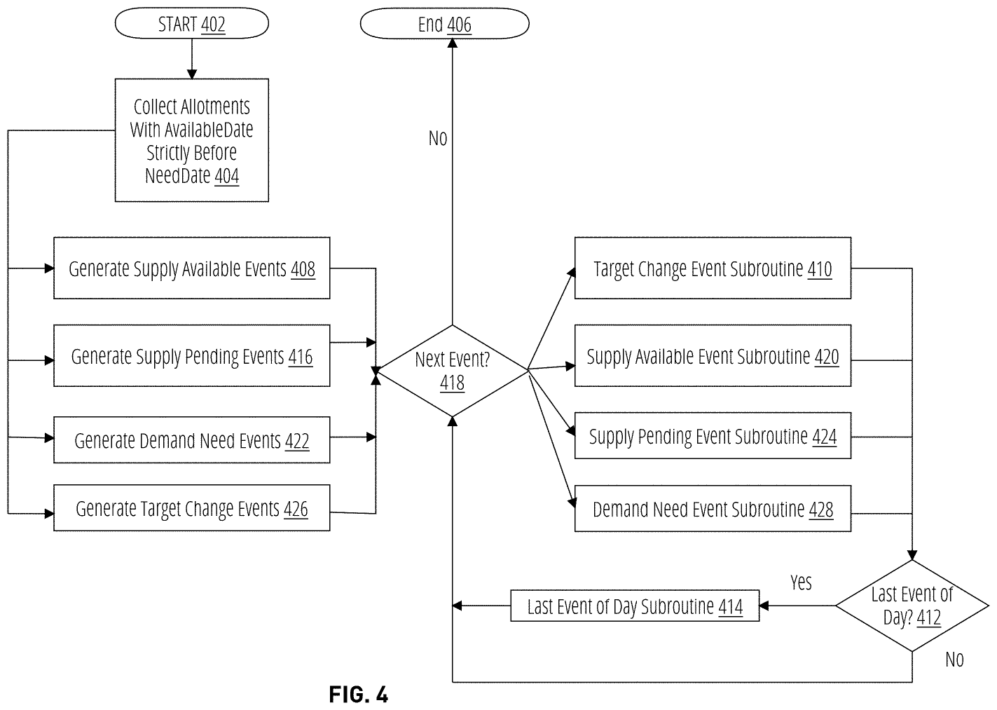

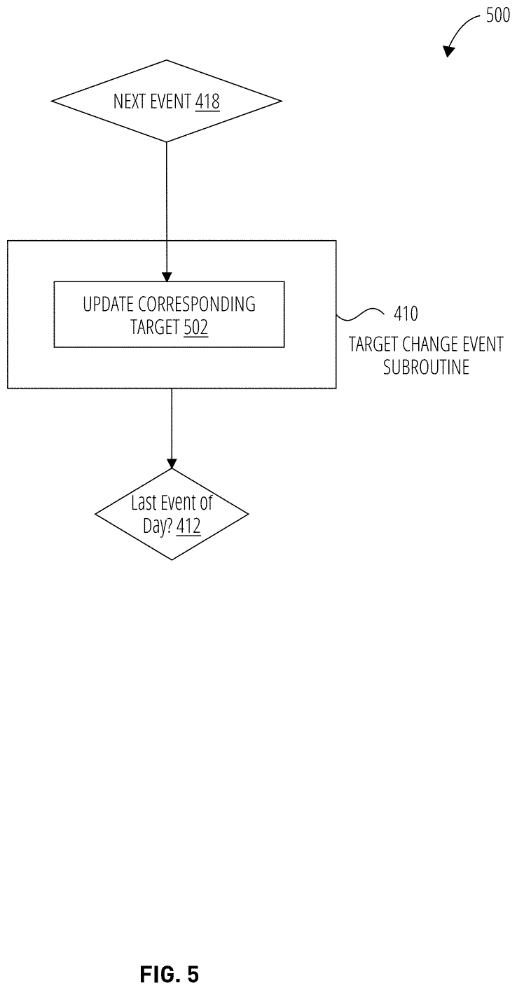

FIG. 5 illustrates a flowchart 500 for a target change event subroutine (block 410 in FIG. 4) in accordance with one embodiment.

If the next event at decision block 418 is a target change event, then target change event subroutine (block 410) is triggered. This corresponds to block 502, where the corresponding target is updated, before proceeding to decision block 412.

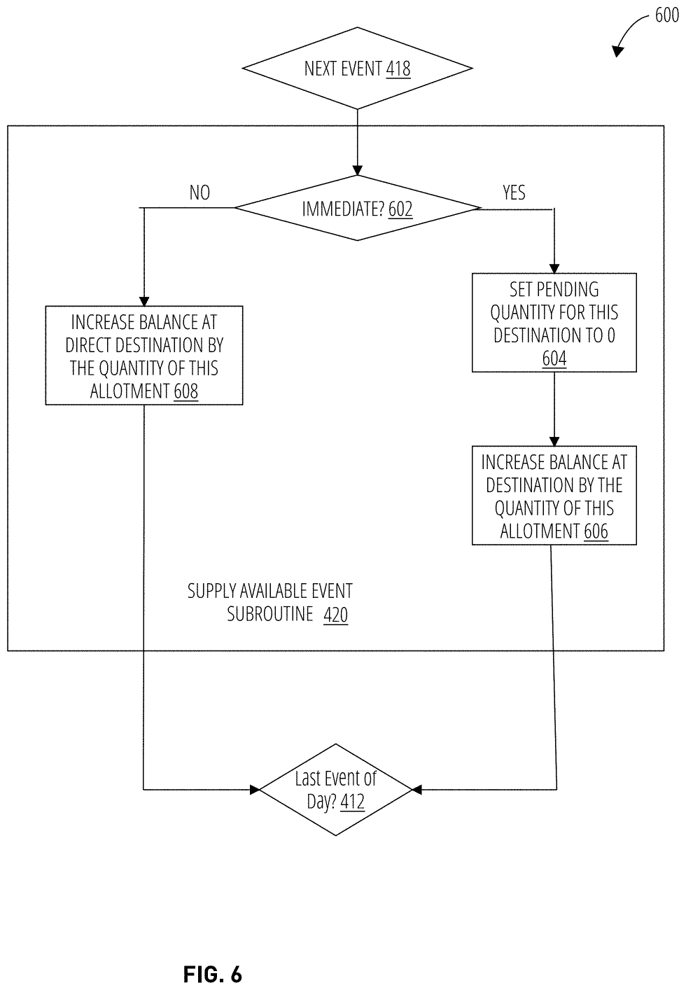

FIG. 6 illustrates a flowchart 600 for a supply available event subroutine (block 420 in FIG. 4) in accordance with one embodiment.

If the next event at decision block 418 is a supply available event, then supply available event subroutine (block 420) is triggered. The first step is decision block 602, to see whether the event is immediate or not.

If the event is immediate, then the pending quantity for this destination is set to ‘0’ at block 604. Then the balance at the destination is increased by the quantity of the allotment at block 606, before proceeding to decision block 412.

If the event is not immediate, then the balance for this destination is increased by the quantity of the allotment at block 608, before proceeding to decision block 412.

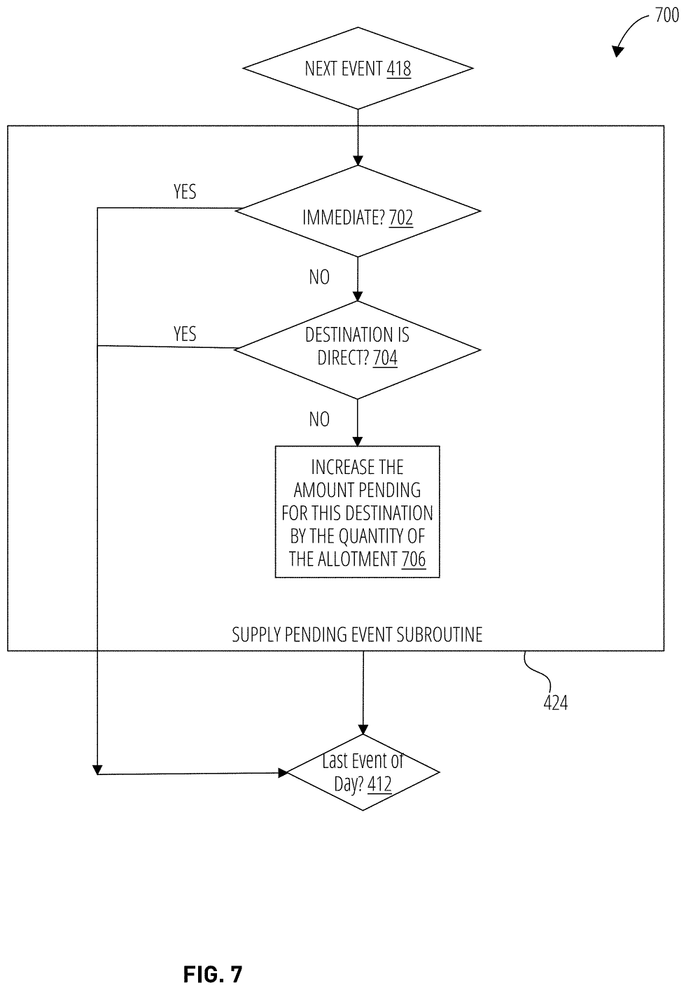

FIG. 7 illustrates a flowchart 700 for a supply pending event subroutine (block 424 of FIG. 4) in accordance with one embodiment.

If the next event at decision block 416 is a supply pending event, then supply pending event subroutine (block 424) is triggered. The first step is decision block 702, to see whether the event is immediate or not. If the event is immediate, then the process proceeds to decision block 412.

If the event is not immediate, then another decision block 704 is triggered, to see if the destination is direct. If it is direct, the process proceeds to decision block 412. If it is not direct, the there is an increase in the amount pending for this destination by the quantify of the allotment at block 706, before proceeding to decision block 412.

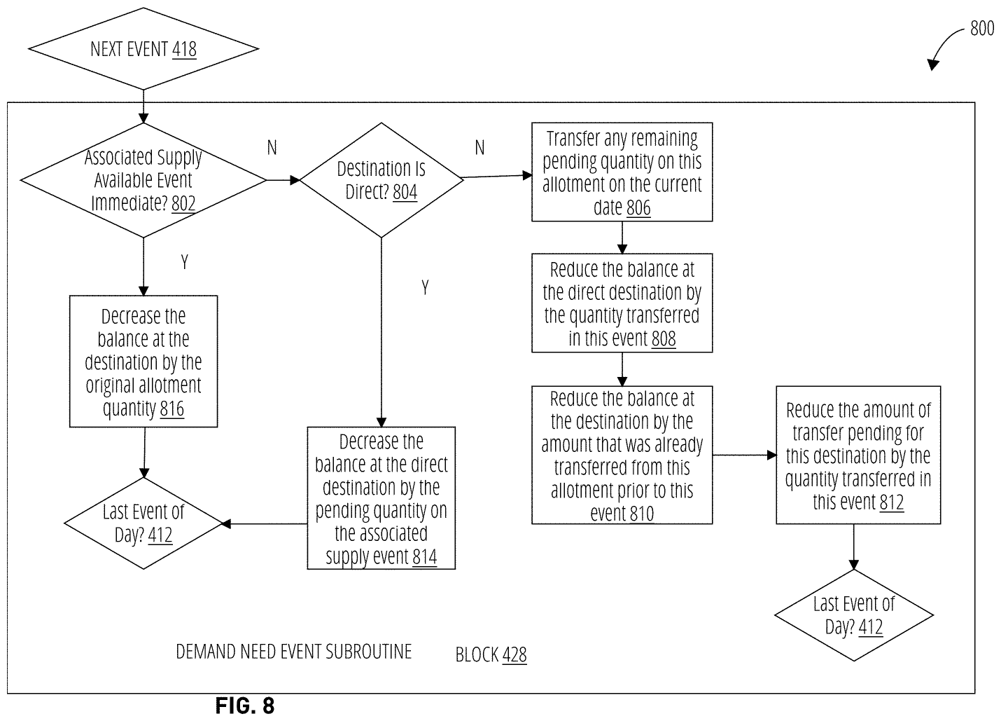

FIG. 8 illustrates a flowchart 800 for a demand need event subroutine (block 428 in FIG. 4) in accordance with one embodiment.

If the next event at decision block 418 is a demand need event, then demand need event subroutine (block 428) is triggered. The first step is decision block 802, to see whether the associated supply available event is immediate or not.

If the associated supply available event is immediate, then there is a decrease in the balance at the destination by the original allotment quantity at block 816, before proceeding to decision block 412, to see if the demand need event is the last event.

If the associated supply available event is not immediate, then there is another decision block 804 to see if the destination is direct. If the destination is direct, then there is there is a decrease in the balance at the direct destination by the pending quantity on the associated supply event at block 814, before proceeding to decision block 412, to see if the demand need event is the last event.

If the destination is not direct, then there are a number of steps before proceeding to decision block 412. First, there is a transfer of any remaining pending quantity on this allotment on the current date at block 806. Then, there is a reduction of the balance at the direct destination by the quantity transferred in the demand need event at block 808. Subsequently, there is a reduction of the balance at the destination by the amount that was already transferred from this allotment prior to the demand need event at block 810. Finally, there is a reduction of the amount of transfer pending for this destination by the quantity transferred in the demand need event at block 812, before proceeding to decision block 412, to see if the demand need event is the last event.

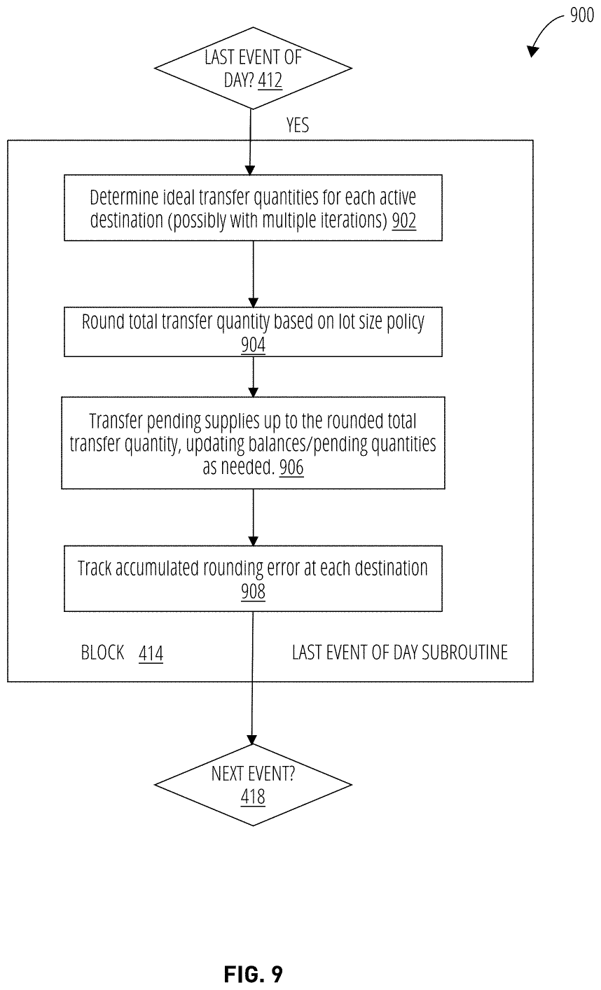

FIG. 9 illustrates a flowchart 900 for a last day of event subroutine (block 414) in accordance with one embodiment.

If the event is the last event of the day at decision block 414, the Last Event of Day subroutine (block 414) is triggered. First, ideal transfer quantities for each active destination are determined (possibly with multiple iterations) at block 902. This is followed by rounding the total transfer quantity based on lot size policy at block 904. Subsequently, there is a transfer of pending supplies up to the rounded total transfer quantity, updating balances/pending quantities as needed at block 906. Finally, the accumulated rounding error at each destination is tracked at block 908, before proceeding to decision block 418.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
collecting, by a processor, allotments having an available date before a need date;
generating, by the processor, one or more supply available events; one or more supply pending events; one or more demand need events; and one or more target change events;
processing, by the processor, each of: the one or more supply available events, the one or more supply pending events, the one or more demand need events, and the one or more target change events sequentially until a last event of a day is reached; and
processing, by the processor, the last event of the day.

2. The computer-implemented method of claim 1, wherein processing a target change event from the one or more target change events comprises:
updating, by the processor, a corresponding target.

3. The computer-implemented method of claim 1, wherein processing a supply available event from the one or more supply available events comprises:
determining, by the processor, an immediacy of the supply available event;
if the supply available event is not immediate:
increasing, by the processor, a balance at a direct destination by a quantity of an allotment; and
if the supply available event is immediate:
setting, by the processor, a pending quantity for a destination to zero; and
increasing, by the processor, a balance at the destination by a quantity of an allotment.

4. The computer-implemented method of claim 1, wherein processing a supply pending event from the one or more supply pending events comprises:
determining, by the processor, an immediacy of the supply pending event;
if the supply pending event is immediate:
determining, by the processor, if the supply pending event is the last event of the day; and
if the supply pending event is not immediate:
determining, by the processor, if a destination is direct;
if the destination is direct:
determining, by the processor, if the supply pending event is the last event of the day; and
if the destination is not direct:
increasing, by the processor, a balance at the destination by a quantity of an allotment.

5. The computer-implemented method of claim 1, wherein processing a demand need event from the one or more demand need events comprises:
determining, by the processor, an immediacy of an associated supply available event;
if the associated supply available event is immediate:
decreasing, by the processor, a balance pending at a destination by an original quantity of an allotment; and
determining, by the processor, if the demand need event is the last event of the day; and
if the associated supply available event is not immediate:
determining, by the processor, if the destination is direct;
if the destination is direct:
decreasing, by the processor, a balance at the destination by a pending quantity on the associated supply available event; and
determining, by the processor, if the demand need event is the last event of the day; and
if the destination is not direct:
transferring, by the processor, any remaining pending quantity on an allotment on a current date;
reducing, by the processor, a balance at the destination by a quantity transferred in the demand need event;
reducing, by the processor, the balance at the destination by an amount previously transferred from the allotment prior to the demand need event;
reducing, by the processor, an amount of transfer pending for the destination by the quantity transferred in the demand need event; and
determining, by the processor, if the demand need event is the last event of the day.

6. The computer-implemented method of claim 1, wherein processing the last event of the day comprises:
determining, by the processor, one or more ideal transfer quantities for each active destination;
rounding, by the processor, a total transfer quantity based on a lot size policy;
transferring, by the processor, pending supplies up to the rounded total transfer quantity;
updating, by the processor, balances and/or pending quantities; and
tracking, by the processor, an accumulated rounding error at each destination.

7. A system comprising:
a processor; and
a memory storing instructions that, when executed by the processor, configure the system to:
collect, by the processor, allotments having an available date before a need date;
generate, by the processor, one or more supply available events; one or more supply pending events; one or more demand need events; and one or more target change events;
process, by the processor, each of: the one or more supply available events, the one or more supply pending events, the one or more demand need events, and the one or more target change events sequentially until a last event of a day is reached; and
process, by the processor, the last event of the day.

8. The system of claim 7, wherein when processing a target change event from the one or more target change events, the system is further configured to:
update, by the processor, a corresponding target.

9. The system of claim 7, wherein when processing a supply available event from the one or more supply available events, the system is further configured to:
determine, by the processor, an immediacy of the supply available event;
if the supply available event is not immediate:
increase, by the processor, a balance at a direct destination by a quantity of an allotment; and
if the supply available event is immediate:
set, by the processor, a pending quantity for a destination to zero; and
increase, by the processor, a balance at the destination by a quantity of an allotment.

10. The system of claim 7, wherein when processing a supply pending event from the one or more supply pending events, the system is further configured to:
determine, by the processor, an immediacy of the supply pending event;
if the supply pending event is immediate:
determine, by the processor, if the supply pending event is the last event of the day; and
if the supply pending event is not immediate:
determine, by the processor, if a destination is direct;
if the destination is direct:
determine, by the processor, if the supply pending event is the last event of the day; and
if the destination is not direct:
increase, by the processor, a balance at the destination by a quantity of an allotment.

11. The system of claim 7, wherein when processing a demand need event from the one or more demand need events, the system is further configured to:
determine, by the processor, an immediacy of an associated supply event;
if the associated supply available event is immediate:
decrease, by the processor, a balance pending at a destination by an original quantity of an allotment; and
determine, by the processor, if the demand need event is the last event of the day; and
if the associated supply available event is not immediate:
determine, by the processor, if the destination is direct;
if the destination is direct:
decrease, by the processor, a balance at the destination by a pending quantity on the associated supply event; and
determine, by the processor, if the demand need event is the last event of the day; and
if the destination is not direct:
transfer, by the processor, any remaining pending quantity on an allotment on a current date;
reduce, by the processor, a balance at the destination by a quantity transferred in the demand need event;
reduce, by the processor, the balance at the destination by an amount previously transferred from the allotment prior to the demand need;
reduce, by the processor, an amount of transfer pending for the destination by the quantity transferred in the demand need event; and
determine, by the processor, if the demand need event is the last event of the day.

12. The system of claim 7, wherein when processing the last event of the day, the system is further configured to:
determine, by the processor, one or more ideal transfer quantities for each active destination;
round, by the processor, a total transfer quantity based on a lot size policy;
transfer, by the processor, pending supplies up to the rounded total transfer quantity, update, by the processor, balances and/or pending quantities; and
track, by the processor, an accumulated rounding error at each destination.

13. A non-transitory computer-readable storage medium, the computer-readable storage medium including instructions that when executed by a computer, cause the computer to:
collect allotments having an available date before a need date;
generate one or more supply available events; one or more supply pending events; one or more demand need events; and one or more target change events;
process each of: the one or more supply available events, the one or more supply pending events, the one or more demand need events, and the one or more target change events sequentially until a last event of a day is reached; and
process the last event of the day.

14. The computer-readable storage medium of claim 13, wherein when processing a target change event from the one or more target change events, the computer is further configured to:
update a corresponding target.

15. The computer-readable storage medium of claim 13, wherein when processing a supply available event from the one or more supply available events, the computer is further configured to:
determine an immediacy of the supply available event;
if the supply available event is not immediate:
increase a balance at a direct destination by a quantity of an allotment; and
if the supply available event is immediate:
set a pending quantity for a destination to zero; and
increase a balance at the destination by a quantity of an allotment.

16. The computer-readable storage medium of claim 13, wherein when processing a supply pending event from the one or more supply pending events, the computer is further configured to:
determine an immediacy of the supply pending event;
if the supply pending event is immediate:
determine if the supply pending event is the last event of the day; and
if the supply pending event is not immediate:
determine if a destination is direct;
if the destination is direct:
determine if the supply pending event is the last event of the day; and
if the destination is not direct:
increase a balance at the destination by a quantity of an allotment.

17. The computer-readable storage medium of claim 13, wherein when processing a demand need event from the one or more demand need events, the computer is further configured to:
determine an immediacy of an associated supply event;
if the associated supply available event is immediate:
decrease a balance pending at a destination by an original quantity of an allotment; and
determine if the demand need event is the last event of the day; and
if the associated supply available event is not immediate:
determine if the destination is direct;
if the destination is direct:
decrease a balance at the destination by a pending quantity on the associated supply event; and
determine if the demand need event is the last event of the day; and
if the destination is not direct:
transfer any remaining pending quantity on an allotment on a current date;
reduce a balance at the destination by a quantity transferred in the demand need event;
reduce the balance at the destination by an amount previously transferred from the allotment prior to the demand need event;
reduce an amount of transfer pending for the destination by the quantity transferred in the demand need event; and
determine if the demand need event is the last event of the day.

18. The computer-readable storage medium of claim 13, wherein when processing the last event of the day, the computer is further configured to:
determine one or more ideal transfer quantities for each active destination;
round a total transfer quantity based on a lot size policy;
transfer pending supplies up to the rounded total transfer quantity;
update balances and/or pending quantities; and
track an accumulated rounding error at each destination.
